(19) United States
(12) Patent Application Publication
(10) Pub. No.: US 2026/0204071 A1
(43) Pub. Date: Jul. 16, 2026

(54) ARTIFICIAL INTELLIGENCE APPARATUS AND OPERATION CONTROL METHOD THEREFOR

(71) Applicant: LG Electronics Inc., Seoul (KR)

(72) Inventors: Sanghee LEE, Seoul (KR); Sungmin PARK, Seoul (KR); Dongyeon SHIN, Seoul (KR); Woonsuk CHANG, Seoul (KR)

(21) Appl. No.: 19/132,606

(22) PCT Filed: Nov. 25, 2022
(86) PCT No.: PCT/KR2022/018795

§ 371 Date: May 23, 2025

(51) Int. Cl. G06V 20/52; F25D 29/00; G06T 7/70; G06V 40/20

(52) U.S. Cl. CPC G06V 20/52; F25D 29/005; G06T 7/70; G06V 40/28; F25D 2500/06; F25D 2700/02; F25D 2700/04; F25D 2700/06; G06V 2201/07

(57) ABSTRACT

Disclosed are an artificial intelligence apparatus and an operation control method therefor. The operation control method for an artificial intelligence device according to at least one of various embodiments disclosed herein may comprise the steps of: detecting door opening; activating an image sensor when the door opens; using the activated image sensor to acquire first image data on a user's body part entering a sensing zone and second image data on the user's body part retreating from the sensing zone; acquiring entry or exit information about an object and calculating position information about the object on the basis of the acquired first image data and second image data on the body parts; generating object management information on the basis of the acquired entry or exit information and the position information about the object; and storing the generated management information about the object.

### TECHNICAL FIELD

The present disclosure relates to an artificial intelligence device and a method of controlling an operation thereof.

### BACKGROUND

Along with the development of digital technology or communication technology, the development of Information and Communications Technology (ICT) technology is remarkable.

Recently, in particular, research on artificial intelligence technology has been conducted a lot, and attempts are being made to apply it to various fields.

As an example, in relation to a real-time entry/exit monitoring method using a food item detection zone for food item inventory management of a home appliance refrigerator, conventional refrigerator inventory management automation mainly used a method using a weight sensor. However, when managing the inventory of a refrigerator using a weight sensor, there were problems such as the difficulty in grasping the inventory and the low accuracy due to the fact that multiple food items were loaded in one location or the size of the object, etc.

In order to solve this problem, there is an attempt to install an image sensor in the refrigerator to directly check the number of items on the shelf. However, in order to check the food items on all the shelves in the refrigerator, at least the number of image sensors is required, and there is a blind spot in food items recognition depending on the installation location of the image sensor, so there is still a problem in inventory management through inventory identification.

### DETAILED DESCRIPTION OF THE INVENTION

### Technical Problem

The problem that the present disclosure seeks to solve is to provide an artificial intelligence device that detects and manages an insertion/removal object and a method for controlling its operation.

The problems that the present disclosure seeks to solve are not limited to the problems mentioned above, and other problems that are not mentioned can be clearly understood by those skilled in the art from the description below.

### Technical Solution

The method for controlling the operation of an artificial intelligence device according to at least one of the various embodiments of the present disclosure for solving the above-described problem may comprise the steps of: detecting door opening; activating an image sensor when the door is opened; obtaining, using the activated image sensor, first image data of a body part of a user entering a detection zone and second image data of the body part of the user retreating from the detection zone; obtaining information on insertion or removal of an object and calculating location information of the object based on the obtained first and second image data of the body part of the user; generating object management information based on the obtained information on insertion or removal of the object and the location information; and storing the generated object management information.

An artificial intelligence device according to at least one of the various embodiments of the present disclosure may comprise: a memory; and a processor configured to communicate with the memory, wherein the processor is configured to detect door opening, activate an image sensor when the door is opened, obtain, using the activated image sensor, first image data of a body part of a user entering a detection zone and second image data of the body part of the user retreating from the detection zone, obtain information on insertion or removal of an object and calculate location information of the object based on the obtained first and second image data of the body part of the user, generate object management information based on the obtained information on insertion or removal of the object and the location information, and store the generated object management information.

Other specific details of the present disclosure are included in the detailed description and drawings.

### Effects of the Invention

According to at least one of the various embodiments of the present disclosure, there is an effect of accurately identifying an insertion or removal object to or from an artificial intelligence device.

According to at least one of the various embodiments of the present disclosure, there is an effect of accurately identifying the location where an insertion object to an AI device is placed.

According to at least one of the various embodiments of the present disclosure, there is an effect of accurately sensing the inside of an AI device by employing a minimum of image sensors, and increasing security as well as improving data processing speed by mounting an AI module.

According to at least one of the various embodiments of the present disclosure, there is an effect of increasing the convenience of inventory management an AI device and providing a new linked service.

### BRIEF DESCRIPTION OF DRAWINGS

FIG. 1 illustrates an AI device according to an embodiment of the present disclosure.

FIG. 2 illustrates an AI server according to an embodiment of the present disclosure.

FIG. 3 illustrates an AI system according to an embodiment of the present disclosure.

FIG. 4 illustrates an AI device according to another embodiment of the present disclosure,

FIGS. 5 to 8 are drawings illustrating a method for controlling the operation of an artificial intelligence device according to an embodiment of the present disclosure.

FIGS. 9 to 13 are drawings illustrating a method for controlling the operation related to an insertion/removal of an artificial intelligence device according to the present disclosure.

FIGS. 14 to 17 are flowcharts illustrating a method for controlling the operation of an artificial intelligence device according to the present disclosure.

FIG. 18 is a drawing illustrating a method for controlling the operation of an artificial intelligence device according to the present disclosure.

### BEST MODE

Hereinafter, embodiments related to the present invention will be described in more detail with reference to the drawings. The suffixes “module” and “part” used for components in the following description are given or used interchangeably only for the convenience of writing the specification, and do not have distinct meanings or roles in themselves.

Artificial Intelligence (AI) refers to a field that studies artificial intelligence or a methodology for creating it, and machine learning (machine learning) refers to a field that defines various problems in the field of artificial intelligence and studies a methodology for solving them. Machine learning is also defined as an algorithm that improves performance for a task through constant experience.

An artificial neural network is a model used in machine learning, and can refer to a model that has problem-solving capabilities, consisting of artificial neurons (nodes) that form a network by combining synapses. An artificial neural network can be defined by the connection pattern between neurons in different layers, the learning process that updates model parameters, and the activation function that generates the output value.

An artificial neural network can include an input layer, an output layer, and optionally one or more hidden layers. Each layer includes one or more neurons, and the artificial neural network can include synapses that connect neurons to neurons. In an artificial neural network, each neuron can output a function value of an activation function for input signals, weights, and biases input through synapses.

Model parameters refer to parameters that are determined through learning, and include the weights of synaptic connections and the biases of neurons. In addition, hyperparameters refer to parameters that must be set before learning in machine learning algorithms, include the learning rate, number of iterations, mini-batch size, and initialization function.

The purpose of learning an artificial neural network can be seen as determining model parameters that minimize the loss function. The loss function can be used as an indicator to determine the optimal model parameters during the learning process of an artificial neural network.

Machine learning can be classified into supervised learning, unsupervised learning, and reinforcement learning depending on the learning method.

Supervised learning refers to a method of learning an artificial neural network when labels for learning data are given, and the labels can refer to the correct answer (or result value) that the artificial neural network must infer when learning data is input to the artificial neural network. Unsupervised learning can refer to a method of learning an artificial neural network when labels for learning data are not given. Reinforcement learning can refer to a learning method that teaches an agent defined in a certain environment to select an action or action sequence that maximizes the cumulative reward in each state.

Among artificial neural networks, machine learning implemented with a deep neural network that includes multiple hidden layers is also called deep learning, and deep learning is a part of machine learning. Hereinafter, machine learning is used to mean deep learning.

Object detection models using machine learning include the single-stage You Only Look Once (YOLO) model and the two-stage Faster Regions with Convolution Neural Networks (R-CNN) model.

The YOLO model is a model that can predict objects and the locations of objects in an image by looking at the image only once.

The YOLO model divides the original image into grids of the same size. Then, for each grid, the number of bounding boxes designated in a predefined shape centered around the center of the grid is predicted, and the reliability is calculated based on this.

After that, whether the image contains an object or only the background is included, and the location with high object reliability can be selected to identify the object category.

The Faster R-CNN model is a model that can detect objects faster than the R-CNN model and the Fast R-CNN model.

Describes the Faster R-CNN model in detail.

First, a feature map is extracted from an image through a CNN model. Based on the extracted feature map, multiple regions of interest (RoIs) are extracted. Rol pooling is performed for each region of interest.

ROI pooling is a process of setting a grid to a predetermined size of H×W for a feature map on which a region of interest is projected, extracting the largest value for each cell included in each grid, and extracting a feature map having a size of H×W.

A feature vector is extracted from a feature map having a size of H×W, and object identification information can be obtained from the feature vector.

Extended Reality (XR) refers to Virtual Reality (VR), Augmented Reality (AR), and Mixed Reality (MR). VR technology provides only CG images of objects or backgrounds in the real world, AR technology provides CG images created virtually on top of images of real objects, and MR technology is a computer graphics technology that mixes and combines virtual objects in the real world.

MR technology is similar to AR technology in that it illustrates real objects and virtual objects together. However, there is a difference in that while AR technology uses virtual objects to complement real objects, MR technology uses virtual objects and real objects with equal characteristics.

XR technology can be applied to Head-Mounted Display (HMD), Head-Up Display (HUD), mobile phones, tablet PCs, laptops, desktops, TVs, digital signage, etc., and a device to which XR technology is applied can be called an XR device.

FIG. 1 illustrates an AI device 100 according to an embodiment of the present disclosure.

The AI device 100 may be implemented as a fixed or movable device, such as a TV, a projector, a mobile phone, a smart phone, a desktop computer, a laptop, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, digital signage, a robot, a vehicle, etc.

Referring to FIG. 1, the terminal 100 may include a communication unit 110, an input unit 120, a learning processor 130, a sensing unit 140, an output unit 150, a memory 170, a processor 180, etc.

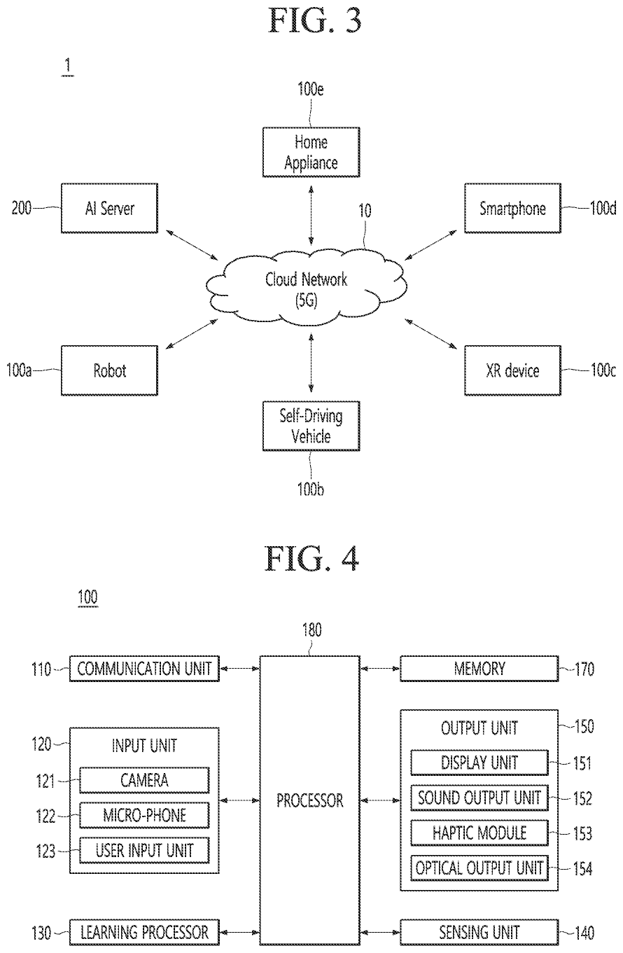

The communication unit 110 may transmit and receive data with external devices, such as other AI devices (100a to 100e of FIG. 3) or an AI server 200, using wired or wireless communication technology. For example, the communication unit 110 can transmit and receive sensor information, user input, learning models, control signals, etc. with external devices.

At this time, the communication technologies used by the communication unit 110 include Global System for Mobile communication (GSM), Code Division Multi Access (CDMA), Long Term Evolution (LTE), 5G, 6G, Wireless LAN (WLAN), Wireless-Fidelity (Wi-Fi), Bluetooth™, Radio Frequency Identification (RFID), Infrared Data Association (IrDA), ZigBee, Near Field Communication (NFC), etc.

The input unit 120 can obtain various types of data.

At this time, the input unit 120 may include a camera for inputting a video signal, a microphone for receiving an audio signal, a user input unit for receiving information from a user, etc. Here, the camera or microphone may be treated as a sensor, and the signal obtained from the camera or microphone may be referred to as sensing data or sensor information.

The input unit 120 may obtain input data to be used when obtaining output using learning data for model learning and a learning model. The input unit 120 may obtain unprocessed input data, and in this case, the processor 180 or the learning processor 130 may extract input features as preprocessing for the input data.

The learning processor 130 may use the learning data to learn a model composed of an artificial neural network. Here, the learned artificial neural network may be referred to as a learning model. The learning model can be used to infer a result value for new input data that is not learning data, and the inferred value can be used as a basis for determination to perform a certain action.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented using a memory 170, an external memory directly coupled to the AI device 100, or a memory maintained in an external device.

The sensing unit 140 can obtain at least one of internal information of the AI device 100, information about the surrounding environment of the AI device 100, and user information using various sensors.

At this time, the sensors included in the sensing unit 140 include proximity sensors, light sensors, acceleration sensors, magnetic sensors, gyro sensors, inertial sensors, RGB sensors, IR sensors, fingerprint recognition sensors, ultrasonic sensors, light sensors, microphones, lidar, radar, etc.

The output unit 150 can generate output related to vision, hearing, or touch.

At this time, the output unit 150 can include a display unit that outputs visual information, a speaker that outputs auditory information, haptic module that outputs tactile information, etc.

The memory 170 can store data that supports various functions of the AI device 100. For example, the memory 170 can store input data, learning data, learning models, learning history, etc. acquired from the input unit 120.

The processor 180 can determine at least one executable operation of the AI device 100 based on information determined or generated using a data analysis algorithm or a machine learning algorithm. Then, the processor 180 can control the components of the AI device 100 to perform the determined operation.

To this end, the processor 180 can request, search, receive, or utilize data from the learning processor 130 or the memory 170, and control the components of the AI device 100 to perform a predicted operation or an operation determined to be desirable among the at least one executable operation.

At this time, if linkage with an external device is required to perform the determined operation, the processor 180 can generate a control signal for controlling the external device and transmit the generated control signal to the external device.

The processor 180 can obtain intention information for a user input and determine the user's requirement based on the obtained intention information.

At this time, the processor 180 may obtain intention information corresponding to the user input by using at least one of a Speech To Text (STT) engine for converting voice input into a string or a natural language processing (NLP) engine for obtaining intention information of natural language.

At this time, at least one of the STT engine or the NLP engine may be configured with an artificial neural network that is at least partially learned according to a machine learning algorithm. In addition, at least one of the STT engine or the NLP engine may be learned by the learning processor 130, learned by the learning processor 240 of the AI server 200, or learned by distributed processing of these.

The processor 180 may collect history information including the operation content of the AI device 100 or the user's feedback on the operation, and store it in the memory 170 or the learning processor 130, or transmit it to an external device such as the AI server 200. The collected history information can be used to update the learning model.

The processor 180 can control at least some of the components of the AI device 100 to drive the application program stored in the memory 170. Furthermore, the processor 180 can operate two or more of the components included in the AI device 100 in combination with each other to drive the application program.

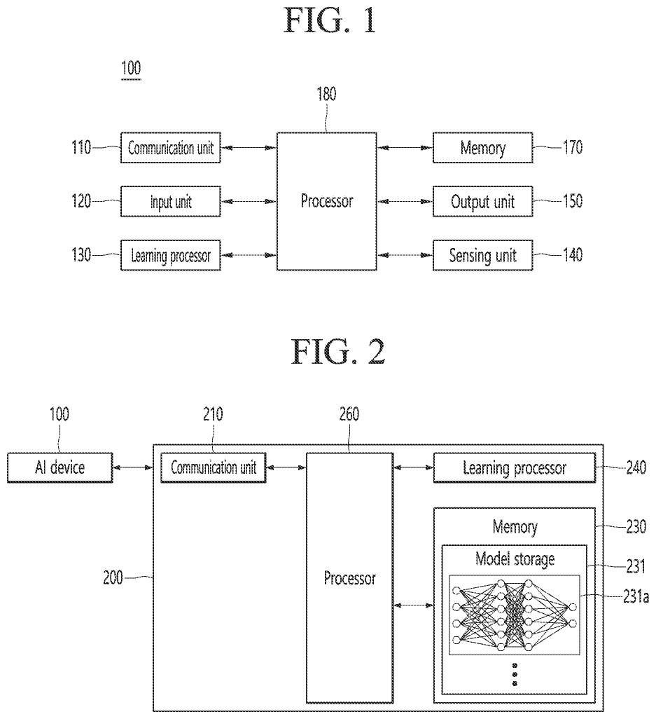

FIG. 2 illustrates an AI server 200 according to an embodiment of the present disclosure.

Referring to FIG. 2, the AI server 200 may mean a device that trains an artificial neural network using a machine learning algorithm or uses a trained artificial neural network. Here, the AI server 200 may be composed of multiple servers to perform distributed processing, and may be defined as a 5G network. In this case, the AI server 200 may be included as a part of the AI device 100 and may perform at least a part of the AI processing together.

The AI server 200 may include a communication unit 210, a memory 230, a learning processor 240, a processor 260, etc.

The communication unit 210 may transmit and receive data with an external device such as the AI device 100.

The memory 230 may include a model storage unit 231, The model storage unit 231 can store a model (or artificial neural network, 231a) being learned or learned through the learning processor 240.

The learning processor 240 can learn the artificial neural network 231a using learning data. The learning model can be used while being loaded on the AI server 200 of the artificial neural network, or can be loaded on an external device such as an AI device 100 and used.

If part or all of the learning model is implemented as software, one or more instructions constituting the learning model can be stored in the memory 230.

The processor 260 can infer a result value for new input data using the learning model, and generate a response or control command based on the inferred result value.

FIG. 3 illustrates an AI system 1 according to an embodiment of the present disclosure.

Referring to FIG. 3, the AI system 1 is connected to at least one of an AI server 200, a robot 100a, an autonomous vehicle 100b, an XR device 100c, a smartphone 100d, or an appliance 100e with a cloud network 10. Here, the robot 100a, the autonomous vehicle 100b, the XR device 100c, the smartphone 100d, or the appliance 100e to which AI technology is applied may be referred to as an AI device 100a to 100e.

The cloud network 10 may mean a network that constitutes part of a cloud computing infrastructure or exists within a cloud computing infrastructure. Here, the cloud network 10 may be configured using a 3G network, a 4G or LTE network, or a 5G network, etc.

That is, each device 100a to 100e, 200 constituting the AI system 1 can be connected to each other through the cloud network 10. In particular, each device 100a to 100e, 200 can communicate with each other through the base station, but can also communicate with each other directly without going through the base station.

The AI server 200 can include a server that performs AI processing and a server that performs calculations on big data.

The AI server 200 is connected to at least one or more of the AI devices constituting the AI system 1, such as a robot 100a, an autonomous vehicle 100b, an XR device 100c, a smartphone 100d, or a home appliance 100e, through the cloud network 10, and can assist at least a part of the AI processing of the connected AI devices 100a to 100e.

At this time, the AI server 200 can train an artificial neural network according to a machine learning algorithm on behalf of the AI device 100a to 100e, and can directly store the learning model or transmit it to the AI device 100a to 100e.

At this time, the AI server 200 can receive input data from the AI device 100a to 100e, infer a result value for the received input data using the learning model, generate a response or control command based on the inferred result value, and transmit it to the AI device 100a to 100e.

Alternatively, the AI device 100a to 100e can directly infer a result value for the input data using the learning model, and generate a response or control command based on the inferred result value.

Hereinafter, various embodiments of the AI device 100a to 100e to which the above-described technology is applied will be described. Here, the AI devices 100a to 100e illustrated in FIG. 3 can be considered as specific examples of the AI device 100 illustrated in FIG. 1.

The XR device 100c can be implemented as an HMD, a HUD equipped in a vehicle, a television, a mobile phone, a smart phone, a computer, a wearable device, a home appliance, a digital signage, a vehicle, a fixed robot or a mobile robot, etc. by applying AI technology.

The XR device 100c can obtain information about a surrounding space or a real object by analyzing 3D point cloud data or image data acquired through various sensors or from an external device to generate location data and attribute data for 3D points, and can render and output an XR object to be output. For example, the XR device 100c can output an XR object including additional information about a recognized object by corresponding it to the recognized object.

The XR device 100c can perform the above-described operations using a learning model composed of at least one artificial neural network. For example, the XR device 100c can recognize a real object from 3D point cloud data or image data using the learning model, and provide information corresponding to the recognized real object. Here, the learning model may be learned directly in the XR device 100c or learned from an external device such as an AI server 200.

At this time, the XR device 100c may generate a result using the learning model and perform the operation, but may also transmit sensor information to an external device such as an AI server 200 and receive the result generated accordingly to perform the operation.

FIG. 4 illustrates an AI device 100 according to an embodiment of the present disclosure.

Descriptions overlapping with FIG. 1 are omitted.

Referring to FIG. 4, the input unit 120 may include a camera (Camera, 121) for inputting a video signal, a microphone (Microphone, 122) for receiving an audio signal, and a user input unit (User Input Unit, 123) for receiving information from a user.

Voice data or image data collected by the input unit 120 may be analyzed and processed as a user control command.

The input unit 120 is for inputting video information (or signal), audio information (or signal), data, or information input from a user. For inputting video information, the AI device 100 may be equipped with one or more cameras 121.

The camera 121 processes image frames such as still images or moving images obtained by an image sensor in a video call mode or a shooting mode. The processed image frame can be displayed on the display unit 151 or stored in the memory 170.

The microphone 122 processes an external acoustic signal into electrical voice data. The processed voice data can be utilized in various ways depending on the function being performed (or the application being executed) in the AI device 100. Meanwhile, various noise removal algorithms can be applied to the microphone 122 to remove noise generated in the process of receiving an external acoustic signal.

The user input unit 123 is for receiving information from a user, and when information is input through the user input unit 123, the processor 180 can control the operation of the AI device 100 to correspond to the input information.

The user input unit 123 may include a mechanical input means (or a mechanical key, for example, a button located on the front/rear or side of the terminal 100, a dome switch, a jog wheel, a jog switch, etc.) and a touch input means. As an example, the touch input means may be composed of a virtual key, a soft key, or a visual key displayed on a touch screen through software processing, or may be composed of a touch key placed on a part other than the touch screen.

The output unit 150 may include at least one of a display unit 151, a sound output unit 152, a haptic module 153, and an optical output unit 154.

The display unit 151 displays (outputs) information processed in the AI device 100. For example, the display unit 151 may display execution screen information of an application program running in the AI device 100, or User Interface (UI) or Graphical User Interface (GUI) information according to such execution screen information.

The display unit 151 can implement a touch screen by forming a mutual layer structure with the touch sensor or forming it as an integral part. This touch screen can function as a user input unit 123 that provides an input interface between the AI device 100 and the user, and at the same time, can provide an output interface between the terminal 100 and the user.

The audio output unit 152 can output audio data received from the communication unit 110 or stored in the memory 170 in a call signal reception, call mode or recording mode, voice recognition mode, broadcast reception mode, etc.

The audio output unit 152 can include at least one of a receiver, a speaker, and a buzzer.

The haptic module 153 generates various tactile effects that the user can feel. A representative example of a tactile effect generated by a haptic module 153 may be vibration.

The light output unit 154 outputs a signal to notify the occurrence of an event using light from a light source of the AI device 100, Examples of events generated by the AI device 100 may include message reception, call signal reception, missed call, alarm, schedule notification, email reception, information reception through an application, etc.

Hereinafter, an artificial intelligence device 100 and its operation control method are described, but the artificial intelligence device 100 is a refrigerator (or smart refrigerator) that detects and manages insertion/removal objects for the convenience of the applicant's explanation. However, the artificial intelligence device 100 according to the present disclosure is not limited to a refrigerator and may include various home appliances that require management of objects within the device.

The artificial intelligence device 100 may provide personalized services or provide information on stored objects. However, for this purpose, the artificial intelligence device 100 may recognize and identify insertion/removal objects and store and manage related information. In addition, the artificial intelligence device 100 may be equipped with artificial intelligence learning hardware (and software) to provide information on object recognition, registration, etc.

There are many limitations to directly observing the inside of the artificial intelligence device 100, i.e., the refrigerator, to manage inventory. A refrigerator, which is an artificial intelligence device 100 that is usually present in a home, can be composed of several parts such as a refrigeration part and a freezing part, and each part adopts a method of opening and closing through a door.

For convenience of explanation, the following description will be given using one part (e.g., a refrigeration part) of a refrigerator, which is an artificial intelligence device 100, as an example, but the present disclosure is not limited thereto.

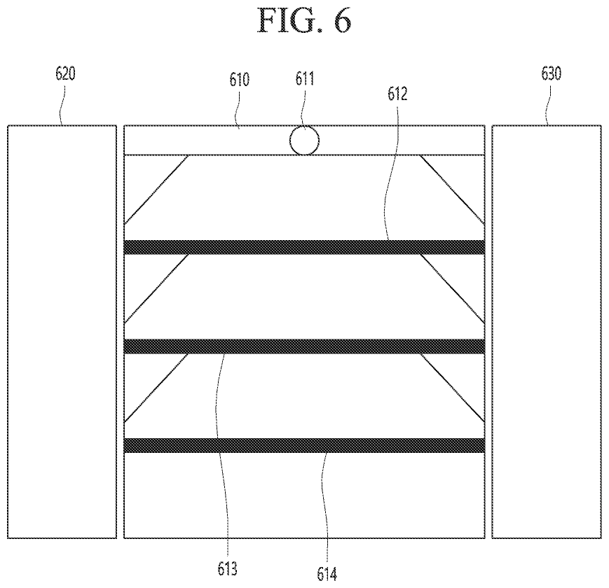

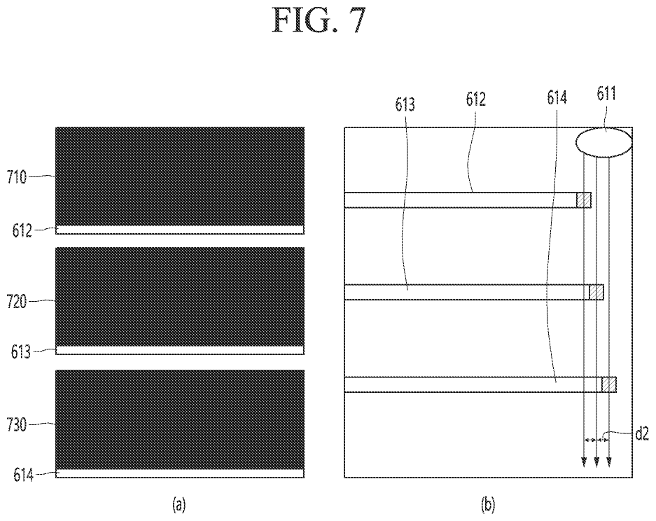

An artificial intelligence device 100 is equipped with an image sensor (e.g., a camera sensor) to recognize an insertion or removal object. A plurality of shelves are usually employed in an artificial intelligence device 100, and when the door is opened, each shelf is generally installed at a different height horizontally when viewed from the front, as shown in FIG. 6. On the other hand, if we assume that this is viewed from above based on the side view of the AI device 100 as shown in FIG. 7(b), most of the areas of the shelves installed at different heights overlap and only some areas do not overlap. Therefore, for example, when detecting and managing insertion or removal objects through an image sensor installed at the top of the AI device 100, observation of the top shelf is easy, but observation of other shelves is limited.

To solve this problem, one solution is to provide an additional image sensor to the AI device 100, but even so, depending on the location of the sensor, there may still be problems with detecting, identifying, and managing objects as the number of insertion objects increases. Another method is to indirectly recognize the quantity by sensing the mass of the object using a weight sensor, but this still has problems. In another way, there may be a combination of the above methods, in which case the design of the refrigerator becomes complicated and the cost increases, as well as the power consumption rating of the device may increase, and there is a concern that the load on processing data collected from many sensors may increase.

The artificial intelligence device 100 according to the present disclosure may provide a method for performing processing such as object detection, identification, and inventory management by performing sensing on each internal shelf with only one image sensor installed at a predetermined location.

In the present disclosure, the object is intended to be recognized and identified during the insertion process of the objectin the artificial intelligence device 100. In addition, the present disclosure identifies the shelf of the insertion object in the artificial intelligence device 100 and the location within the shelf, so that the insertion object can be managed efficiently.

To this end, the present disclosure may define the process of insertion and/or removal objects step by step, and may provide audio as feedback during the process, thereby helping the user use the artificial intelligence device 100 and manage inventory. For example, the AI device 100 can provide the user with accurate and convenient management of the AI device 100, object management, etc.; through registration as well as the aforementioned feedback for insertion or removal objects.

Hereinafter, the object generally includes food items, etc. due to the characteristics of the refrigerator, which is an AI device 100, but is not necessarily limited thereto. Meanwhile, food items refer to the contents, and not only food items with the original packaging intact, but also food items without packaging but with the contents contained in dishes, etc. can be considered as one food item, i.e., an object.

In addition, the insertion or removal refers to a case where an object is finally brought into or taken out of the AI device 100. Of course, even if the user's body parts, especially the hands and arms, pass through the detection area described below, cases where the object is not brought in or taken out can be identified, but for convenience, such cases are not included in the definition of the insertion or removal stage, but can be referenced for inventory management. However, a detailed description of the relevant cases is omitted.

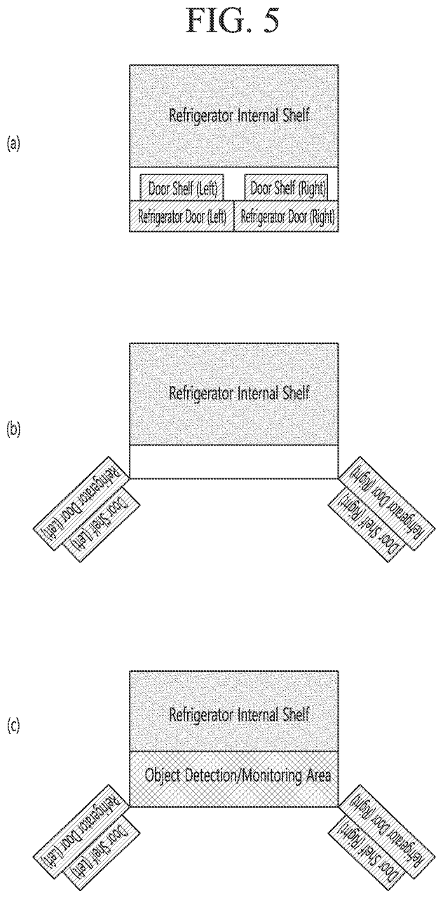

FIGS. 5 to 8 are drawings illustrating a method for controlling the operation of an artificial intelligence device 100 according to an embodiment of the present disclosure.

In the present disclosure, the artificial intelligence device 100 can detect and identify an insertion or removal object through an image sensor (e.g., a top-view image sensor) provided at the top. At this time, the artificial intelligence device 100 can set an inspection zone (or detection area) for determining the insertion or removal in order to detect the insertion or removal object. For example, if a person's hand or arm or an object enters the inspection zone (i.e., movement from the outside toward the inside of the artificial intelligence device 100, it can be determined as insertion, and an object processing method for receiving can be applied. On the other hand, if a person's hand or arm or an object retreats from the inspection zone (i.e., movement from the inside of the artificial intelligence device 100 toward the outside), it can be determined as removal, and an object processing method for removal can be applied.

The artificial intelligence device 100 can determine whether a person's hand passes through the detection zone (i.e., insertion or removal), but in this case, if an object is not detected when passing through the detection zone, it may not be considered as insertion or removal. In other words, even if the detection zone is passed, no insertion or removal object may be existed. The artificial intelligence device 100 according to the present disclosure can identify and operate in such a case, but as described above, a detailed description thereof is omitted.

The image sensor mounted on the artificial intelligence device 100 receives real-time image data on an entity passing through the detection zone and processes it in real time to analyze information on the entity and determine each predefined insertion/removal stage. Meanwhile, in this specification, the term “entity” may be used to collectively refer to a person's hand or arm and/or an object such as food items. Therefore, even if it is described as an entity, it may mean only a human body part or only food items and an object depending on the context.

The artificial intelligence device 100 can provide information on the final determination object, information on whether it is in stock or out, through a display, and can perform internal inventory management of the artificial intelligence device 100 based on such information. In the above, the display can indicate, for example, at least one of a display mounted on the artificial intelligence device 100, a display mounted on a terminal of a registered user, and a display mounted on another registered external terminal.

Meanwhile, the artificial intelligence device 100 according to the present disclosure can provide a guide to the user according to each predefined insertion/removal step.

FIG. 5 is a drawing illustrating a detection zone in the artificial intelligence device 100.

FIG. 5(a) illustrates a case where the door of the refrigerator, which is the artificial intelligence device 100, is closed, and FIG. 5(b) illustrates a case where the door is open.

Meanwhile, FIG. 5(c) illustrates a detection zone for detecting an object when the door is open, as in FIG. 5(b).

Referring to FIG. 5(c), the detection zone may correspond to only a part of each shelf. For example, the detection zone may be located at the end of each shelf (the area that is first exposed to the outside when the door is opened) and may be formed with a predetermined length and width. However, the present disclosure is not limited thereto.

Meanwhile, in FIG. 5(c), at least one detection zone of each shelf may be equipped with a detection sensor for detecting an object separately from the top-view image sensor described above. Therefore, by comparing and combining the fact of detecting an object through the detection sensor and the sensing content through the top-view image sensor, the accuracy of recognition and identification of the object may be increased.

If FIG. 5 is a drawing of a top view of a shelf structure of an artificial intelligence device 100, FIG. 6 may be a drawing of a front view.

Referring to FIG. 6, the artificial intelligence device 100 may be configured to include a body 610 including a plurality of shelves 612-614 and a door 620, 630.

At this time, a top-view image sensor 611 is installed on the top of the body of the artificial intelligence device 100 to perform sensing for the detection zone of each shelf.

FIG. 7(a) is a drawing to explain the detection zone of each shelf, and FIG. 7(b) is a side view of the artificial intelligence device 100 including the shelf.

In FIG. 7(a), three shelves, i.e., an upper shelf 710, a middle shelf 720, and a lower shelf 730, are illustrated for convenience, and a detection zone 612-614 is formed at the end of each shelf.

Referring to FIG. 7(a), it seems difficult to sense an object using a top-view image sensor 611 because the detection zones of each shelf coincide with each other in a planar view, but as illustrated in FIG. 7(b), the shelves can be implemented to have a predetermined interval (d1, d2) so that the detection zones do not overlap each other when viewed from the side. Accordingly, the top-view image sensor 611 can accurately identify which shelf's detection zone an object passes through and which shelf it is entered or retreated from.

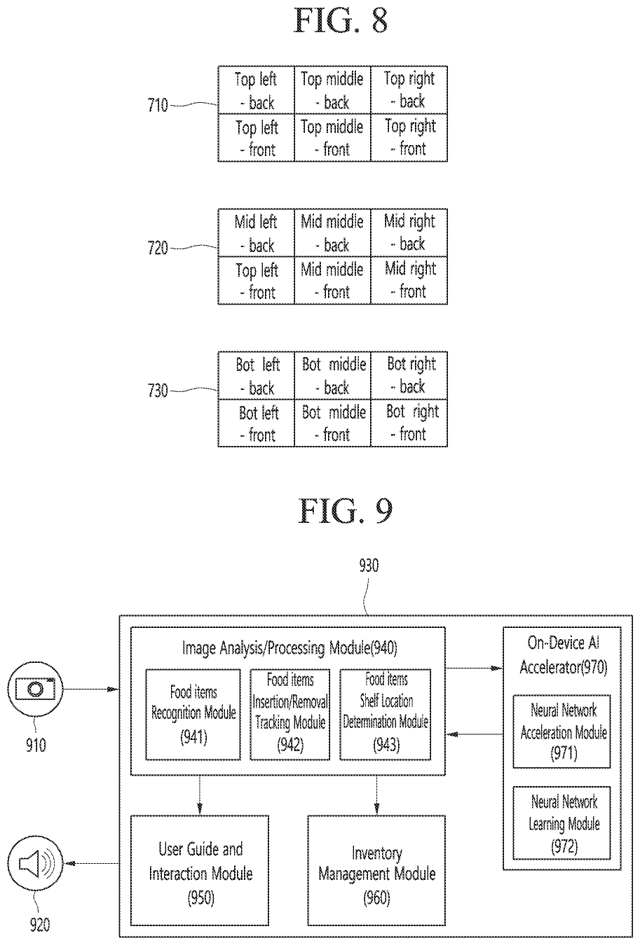

FIG. 8 describes detailed areas within each shelf. At this time, the sub-area refers to an area arbitrarily divided to identify the space where an object can be loaded within the shelf excluding the detection area.

In FIG. 8, for the convenience of explanation, each shelf is divided into six sub-areas and each sub-area is defined in a rectangular shape, but the present disclosure is not limited thereto. However, if too many sub-areas are defined for each shelf, it is difficult to recognize and identify the object during the insertion or removal process, so it is desirable to define an appropriate number of sub-areas.

Meanwhile, in FIG. 8, if an object spans at least two or more sub-areas within a specific shelf, the sub-area where the object is located the most may be assigned as a representative sub-area. Meanwhile, in the above case, the artificial intelligence device 100 may display all sub-areas to determine the size of the object and use them as a reference for providing guide information. In addition, unlike FIG. 8, the artificial intelligence device 100 may not define the sub-areas in advance, but may arbitrarily assign and define the aforementioned sub-areas according to the location of the object being stored and loaded into the artificial intelligence device 100.

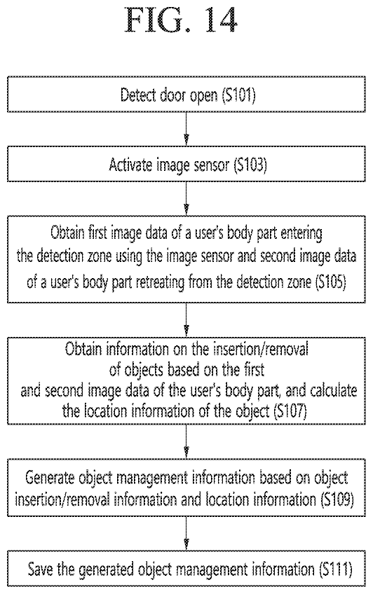

FIG. 14 is a flow chart illustrating an operation control method of an artificial intelligence device 100 according to an embodiment of the present disclosure.

The artificial intelligence device 100 can detect a door opening (S101).

The artificial intelligence device 100 can activate an image sensor (S103).

The artificial intelligence device 100 can obtain first image data of a user's body part entering a detection zone and second image data of a user's body part retreating from the detection zone using the image sensor (S105).

The artificial intelligence device 100 can obtain information on the insertion/removal object based on the first and second image data of the user's body part and calculate information on the location of the object (S107).

The artificial intelligence device 100 can generate information on the insertion/removal object and object management information based on the location information (S109).

The artificial intelligence device 100 can store the generated object management information (S111).

In FIG. 14, the object management information may indicate or include the aforementioned inventory management information.

Image data on the user's body part may be used to determine whether the user is empty-handed or holding an object in his hand. In addition, when entering the detection zone, an object is included in the hand, but when retreating, the object is not in the hand, which may be defined as an insertion stage, and the opposite case may be defined as a removal stage.

Hereinafter, with reference to FIGS. 9 to 13, the configuration and operation of the artificial intelligence device 100 according to the present disclosure will be described in more detail as follows.

The artificial intelligence device 100 according to one embodiment of the present disclosure can be configured to include an image sensor, a memory, and a processor,

FIG. 9 can describe a process of defining and operating an object insertion/removal stage in the artificial intelligence device 100 or processor according to one embodiment of the present disclosure.

The present disclosure is an example of a method for monitoring/detecting the insertion/removal object in real time and performing inventory management based on it using only a single top-view image sensor installed on the top of an artificial intelligence device, a refrigerator.

Referring to FIG. 9, an artificial intelligence device 100 may include an image sensor 910, an audio output module 920, and a processor 930.

The processor 930 may include an image analysis/processing module 940, a user guide and interaction module 950, an inventory management module 960, and an on-device artificial intelligence accelerator 970.

The image sensor 910 defines a detection zone, which is an external/inner boundary of the artificial intelligence device 100, and the image sensor data may obtain real-time continuous images of an object entering/retreating from the detection zone. These images may not necessarily represent still images but may also be in the form of a video. In addition, the AI device 100 can perform capture, etc. of a necessary area from an image acquired from an image sensor 910.

The image sensor data is not transmitted to the outside of the AI device 100 and can be processed only within the image analysis/processing module 940. Through this, the data security of the AI device 100 can be enhanced.

The image analysis/processing module 940 can analyze information on food items and the locations of food items in and out of the shelves using the image sensor data through the image sensor 910.

At this time, the information on the food items can include, for example, the name of the food items, the date of insertion and removal of the food items, etc. In addition, the insertion and removal of the food items can indicate the insertion and removal of the food items. In addition, the location on the shelf of the food items can indicate the top shelf, the middle shelf, the bottom shelf, the left, middle, and right within each shelf, and the front and back within each shelf, as illustrated in FIG. 8.

The image analysis/processing module 940 can receive image data about an object acquired from the image sensor 910.

The image analysis/processing module 940 can determine a food item recognition module 941, a food item insertion/removal tracking module 942, a food item shelf location determination module 943, etc.

The food item recognition module 941 can recognize whether food items is included in the received image data.

The food item insertion/removal tracking module 942 can identify food item insertion/removal tracking information based on the received image data.

The food item shelf location determination module 943 can determine the location of the corresponding shelf if food items is included in the received image data, and generate location information based on the determination result.

The image analysis/processing module 940 can report the fact to the user guide and interaction module 950 if an object enters the detection zone. The user guide and interaction module 950 can transmit the fact that an object has entered the detection zone to the audio output module 920 so that it can be output to the user.

The image analysis/processing module 940 can determine and generate food item insertion/removal tracking information as described above and transmit it to the inventory management module 960. The inventory management module 960 can also control the generated food item insertion/removal tracking information to be transmitted to the display of the artificial intelligence device 100, the audio output module 920, or other user terminals (not shown) so that it can be output.

The inventory management module 960 can manage the analyzed insertion/removal and food item information.

The inventory management module 960 can manage the inventory (number of food items, location of food items on the shelf, etc.) using the information on the accumulated food items processed for insertion/removal (food item name, date, etc.).

The inventory management module 960 may operate in the image analysis/processing hardware module within the artificial intelligence device 100 or may operate in a separate inventory management hardware module.

The user guide and interaction module 950 may provide a guide and a user interface (UI) to the user through the audio output module 920 based on the processing result of the image analysis/processing module 940.

In the present disclosure, the artificial intelligence device 100 may be referred to as an on-device artificial intelligence accelerator, including a neural network acceleration model 971 and a neural network learning module 972, without transmitting data outside. The neural network acceleration model 971 and the neural network learning module 972 may be hardware configurations.

The image analysis/processing module 940 may utilize the on-device artificial intelligence accelerator 970 when neural network operation processing is required.

The on-device AI accelerator 970 improves misrecognition occurring in the user environment t by utilizing the neural network learning module of the on-device AI accelerator when the food item recognition module 941 recognizes food items using a neural network.

The on-device AI accelerator 970 can perform the following operations.

When the on-device AI accelerator 970 receives misrecognition feedback from the user, it can store information (image) of the corresponding food item.

When food item data having a high similarity to the food items that received misrecognition feedback enters the food item monitoring/detection area, the on-device AI accelerator 970 can collect and store image data collected from the image sensor 910.

The on-device AI accelerator 970 can receive correction feedback from the user as a representative image of the collected data, or can label data based on the initially received misrecognition feedback.

The on-device AI accelerator 970 can learn the collected data that received correction feedback as learning data through the learning module of the on-device AI accelerator 970 to obtain an improved AI recognition model.

The on-device AI accelerator 970 can update the improved AI recognition neural network model to the food item recognition module 941.

The on-device AI accelerator 970 can return the result of AI acceleration processing by combining the image data received from the image analysis/processing module 940 with the neural network acceleration module 971 and the neural network learning module 972. The on-device AI accelerator 970 can return the result of food item recognition, food item insertion/removal tracking, and food item shelf location determination through image analysis.

The accuracy of the function (food item recognition performance) operating in the image analysis/processing module 940 can be continuously improved through updates.

The food item shelf location determination module 943 determines the shelf food item location based on the center point of the object, and can determine which space is occupied by referring to the outer coordinates of the object.

In the food item shelf location determination module 943, the shelf food item location determination can be determined by looking at which part of the point where the object enters the shelf (the end of the shelf) and the center point of the object and the outer coordinates of the object pass through.

The food item shelf location determination module 943 can provide a recommendation guide on where to store the food items (object) held by the user based on the location where the food items are currently stored. For example, if the user is holding meat, the food item shelf location determination module 943 can recommend a shelf where meat is mainly stored and a predetermined area of the shelf.

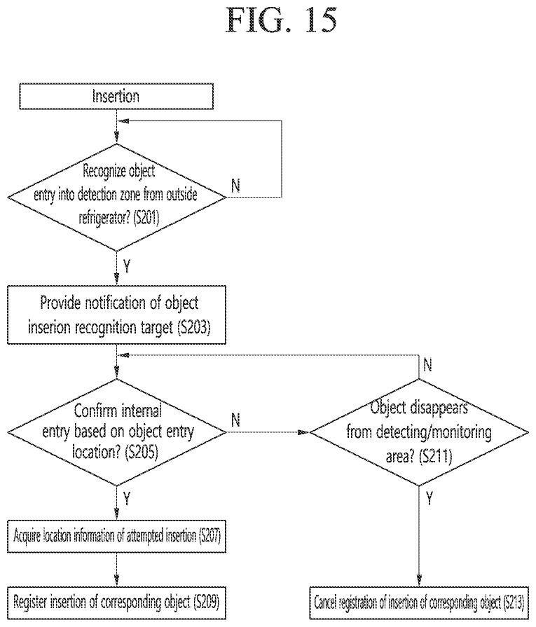

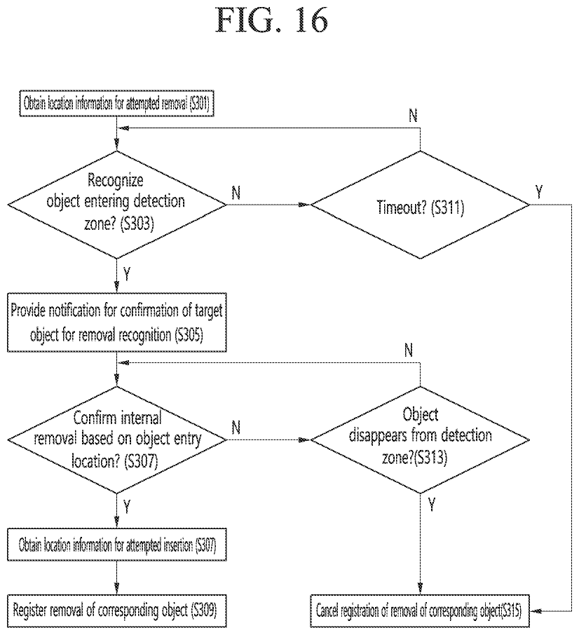

In FIGS. 15 and 16, the insertion stage and the removal stage are described, respectively, with respect to the aforementioned FIG. 9.

First, referring to FIGS. 9 and 15, the insertion stage is described as follows.

The food item insertion registration procedure can be performed as follows.

The artificial intelligence device 100 can determine whether food items have entered the detection zone (S201).

The artificial intelligence device 100 can recognize whether food items observed from an image received through an image sensor 910 have entered the detection zone using the food item recognition module 941 in the image analysis/processing module 940, and can provide a confirmation notification to the user regarding the fact that the insertion recognition target object has entered the detection zone (S203).

The artificial intelligence device 100 tracks the location, movement direction, and path of food items that entered the food item detection zone observed through the image sensor 910 through the food item insertion/removal tracking module 942 in the image analysis/processing module 940, and if it is determined that the food items entered from the outside to the inside, it can be determined as insertion (S205).

The artificial intelligence device 100 determines whether the food items that entered the food item detection zone observed through the image sensor 910 entered the upper, middle, or lower shelf through the food item shelf location determination module 942 in the image analysis/processing module 940 (for example, by determining which part of the shelf the hand and the food items pass through), and can determine whether it entered the left, middle, or right shelf (S207).

The artificial intelligence device 100 can process food items recognized in the food item detection zone as an insertion, and register the information of the food items (type, insertion date, etc.) and the storage location (shelf top, middle, bottom/left, center, right, etc.) (S209).

The artificial intelligence device 100 can measure the time when a hand/food items, etc. invades the shelf to determine how deep the food item is in the shelf (e.g., front/back of the shelf).

The artificial intelligence device 100 can only determine whether the object disappears from the detection zone area based on the determination result of step S205 (S211), and if it disappears, can cancel the insertion registration of the object (S213).

Next, referring to FIGS. 9 and 16, the removal step is described as follows.

The artificial intelligence device 100 can determine whether food items are being attempted to be retreated from the upper, middle, or lower shelf through the image sensor 910, and can determine (for example, determine which part of the shelf the hand and food items pass through) through the food item shelf location determination module 942 in the image analysis/processing module 40.

The artificial intelligence device 100 can determine whether food items are being attempted to be retreated from the left, middle, or right through the image sensor 910, and can determine (for example, determine) through the food item shelf location determination module in the 942 image analysis/processing module.

The artificial intelligence device 100 can determine how deep the food items are in the shelf by measuring the time that the hand/food items, etc. passes through the detection zone of the corresponding shelf. This can be inferred from the degree to which the hand or arm passes through the detection zone.

When food items enter the detection zone, the AI device 100 can recognize the food items that entered the food item detection zone observed through the image sensor 910 through the food item recognition module 941 in the image analysis/processing module and inform the user of this (food item entering the detection zone).

The AI device 100 can track the location, movement direction and path of the food items that entered the food item detection zone observed through the image sensor 910 through the food item insertion/removal tracking module 942 in the image analysis/processing module and determine that it has been taken out from the inside.

The AI device 100 can process the food items recognized in the food item detection zone as a removal, register information about the food items (e.g., type, removal date, etc.) and register the location where it was stored (specific shelf top/middle/bottom/left/right, etc.).

When the location information of the attempted removal is obtained (S301), and when the object entering the detection zone is recognized (S303), a notification of confirmation of the target object for removal recognition can be provided (S305).

However, if the result of the determination in step S303 is that the object entering the detection zone is not recognized for a predetermined time, it can be determined as a time-out and returned to the standby state (stand-by or ready) (S311).

Whether or not removal is possible can be confirmed based on the object entry location (S307), and if the confirmation result is correct, removal registration for the object can be performed (S309).

On the other hand, if removal is not confirmed in step S307, it can be confirmed whether the object has disappeared from the detection zone (S313), and the removal registration procedure for the object can be canceled (S315).

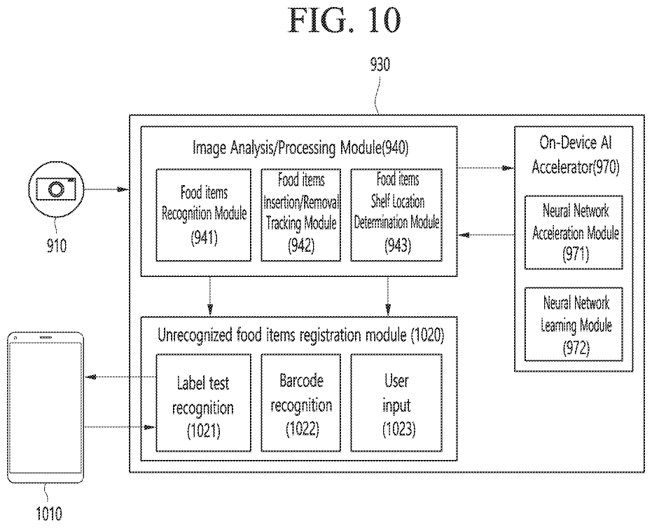

FIG. 10 may include a configuration for processing when, for example, an object is detected through the food item recognition module 941 in FIG. 9, but it cannot accurately recognize whether the object is food item or, if so, what type or kind it is.

Therefore, in FIG. 10, the description of the configuration overlapping with FIG. 9 refers to the contents of FIG. 9 described above, and the overlapping description is omitted.

The artificial intelligence device 100 according to the present disclosure may provide a method for processing an object that cannot accurately identify a food item name, that is, an unknown object.

For example, when the artificial intelligence device 100 cannot identify a food item name, it may attempt to identify the object through text, barcode, etc. included in the label of the product.

Nevertheless, when the artificial intelligence device 100 has difficulty accurately recognizing the food item name, etc. of the object, it may provide a notification to the user to directly induce registration of information on the object. Afterwards, the information can be referenced for updating the learning model.

Meanwhile, the artificial intelligence device 100 extracts the color, size, and feature points of the object through the image sensor 910, and estimates and provides the food item name of the object based on this, but provides the estimated food item name in a differentiated manner from other objects for the user's feedback, and can determine the final food item name based on the user's feedback.

In relation to this, the processor 930 may further include an unrecognized food item registration module 1020.

The unrecognized food item registration module 1020 may be configured to include a label text recognition module 1021, a barcode recognition module 1022, a user input reception module 1023, etc.

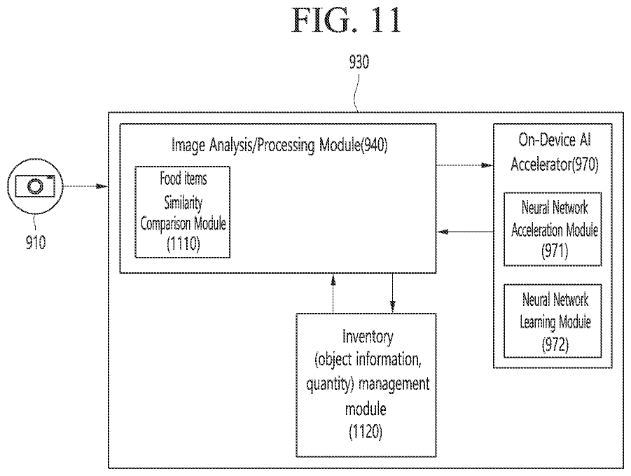

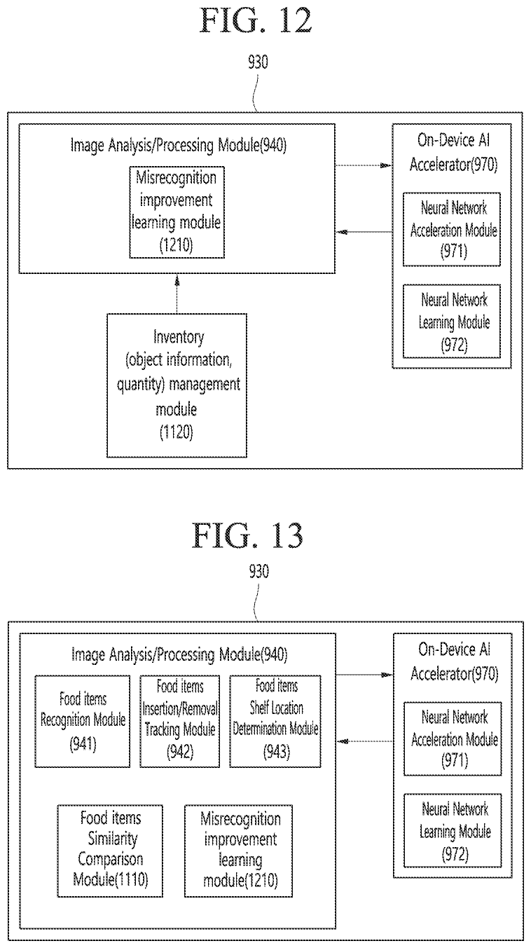

FIGS. 11 and 12 illustrate components for information processing and improvement regarding food item misrecognition/non-recognition.

First, FIG. 11 describes a configuration for collecting and processing misrecognition based on misrecognition feedback.

The image analysis processing module 940 may further include a food item similarity comparison module 1110. The food item similarity comparison module 1110 may compare misrecognition targets with similarity.

In relation to this, the inventory management module 1120 may collect misrecognition data from the image analysis/processing module 940 and provide misrecognition target information to the image analysis/processing module 940 so that the food item similarity comparison module 1110 may perform a similarity comparison with the misrecognition target.

Next, FIG. 12 describes learning with collected misrecognition data.

The image analysis/processing module 940 may include a misrecognition improvement learning module 1210.

The inventory management module 1120 collects misrecognition data, organizes it into a misrecognition data set, labels it, and transfers it to the image analysis/processing module 940. Then, the misrecognition improvement learning module 1210 transfers the related data to the on-device AI accelerator 970 to learn and update the learning model.

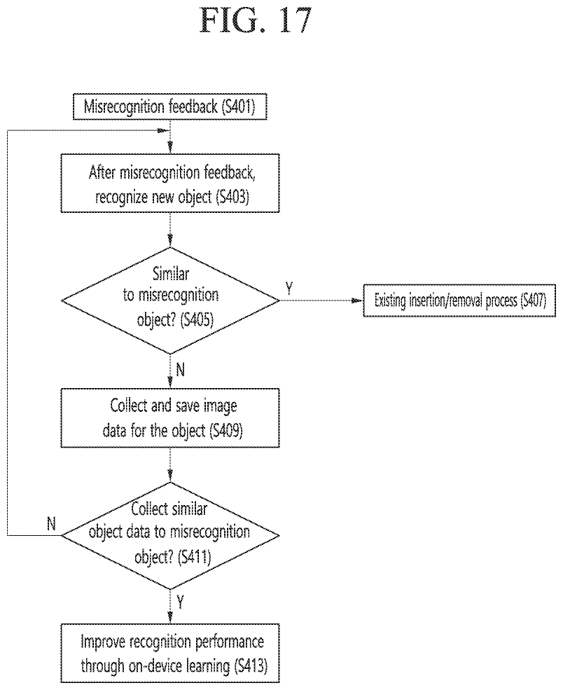

In FIG. 17, a processing method related to misrecognition feedback is disclosed.

When the AI device 100 receives misrecognition feedback (S401), when a new object is recognized (S403), it can determine the similarity with the misrecognition object (S405).

If the result of the determination in step S405 is similar, it can control to perform the existing insertion/removal process.

However, if the new object is not similar to the misrecognized object as a result of the determination in step S405, image data for the object can be collected and stored (S409).

Afterwards, if data for objects similar to the misrecognized object are collected (S411), recognition performance can be improved through on-device learning (S413).

FIG. 13 illustrates the entire configuration of the image analysis processing module 940 individually configured in FIGS. 9 to 12 described above. At this time, the description of each component refers to the description of FIGS. 9 to 12 described above, and redundant descriptions are omitted.

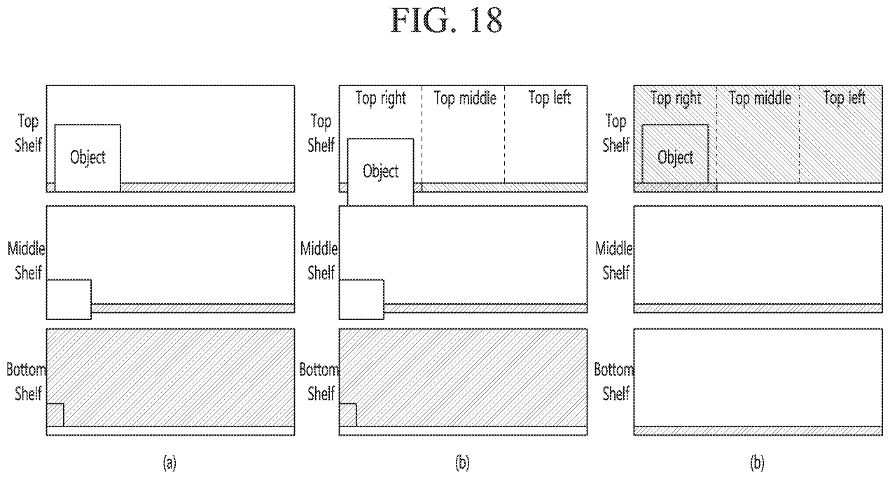

FIG. 18 illustrates an example of a scenario regarding a method for detecting, recognizing, and determining the location of an object.

First, referring to FIG. 18(a), based on an image acquired from an image sensor of an artificial intelligence device 100, the end of each shelf can be monitored, and the entry location can be determined based on the monitoring result.

Also, referring to FIG. 18(b), if it is determined which shelf the object has entered based on the image acquired from the image sensor of the artificial intelligence device 100, then it is also possible to determine which position it is placed in within the shelf.

Referring to FIG. 18(c), the left, middle, and right positions on the shelf can be determined based on the center point and outer point of the object.

As described above, a single shelf can be divided into left, middle, and right based on the set criteria.

It is possible to determine where the object is placed based on the point where the center point and outer point of the object enter the shelf.

Meanwhile, referring to FIG. 18(c), the depth (front, back) position of the object can be determined based on the time it takes for the hand to retreat after entering the shelf.

In addition, the AI device 100 can perform the role of the internal image analysis/processing module in an external device such as a home smart hub located outside the device.

At least one of the operations or functions of the AI device 100 described above can be performed by a server (not shown) provided by the manufacturer of the AI device 100.

The operation order described in the present disclosure is not necessarily limited to the order described in the drawings or in the specification, and some operations may be performed together or in a different order than shown depending on the embodiment.

According to at least one of the various embodiments of the present disclosure described above, it is possible to accurately determine objects being put in and out of the refrigerator by observing the external/inside boundaries of the refrigerator, and to determine which shelf and which location the food items are in by tracking the movement of the food items. In addition, according to the present disclosure, by employing a minimum number of image sensors, it is possible to accurately sense the inside of multiple shelves, to improve data processing speed by installing an artificial intelligence module in the device, to enhance security, and to provide new usage scenarios and usage methods for artificial intelligence devices, thereby not only increasing the convenience of inventory management but also providing new linked services.

According to one embodiment of the present invention, the above-described method can be implemented as a code that can be read by a processor in a medium in which a program is recorded. Examples of the medium that can be read by a processor include ROM, RAM, CD-ROM, magnetic tape, floppy disk, optical data storage device, etc.

The display device described above is not limited to the configuration and method of the embodiments described above, and the embodiments can be configured by selectively combining all or part of each embodiment so that various modifications can be made.

### INDUSTRIAL APPLICABILITY

According to the method for controlling the operation of an artificial intelligence device according to the present disclosure, detection, recognition, and accurate identification of various insertion/removal objects to/from the artificial intelligence device are possible, and based on this, inventory management and recommendation guides are performed, thereby improving the user's convenience and satisfaction in using the artificial intelligence device, and thus, there is industrial applicability.

What is claimed is:

1. A method of controlling an operation of an artificial intelligence device, comprising:
detecting door opening;
activating an image sensor when the door is opened;
obtaining, using the activated image sensor, first image data of a body part of a user entering a detection zone and second image data of the body part of the user retreating from the detection zone;
obtaining information on insertion or removal of an object and calculating location information of the object based on the obtained first and second image data of the body part of the user;
generating object management information based on the obtained information on insertion or removal of the object and the location information; and
storing the generated object management information.

2. The method according to claim 1, further comprising:
detecting a door closing; and
controlling the stored object management information to be output when the user is detected using a detection sensor provided an outside of the artificial intelligence device after the door closing or when the door is closed.

3. The method according to claim 2, wherein the object management information includes recommended object insertion/removal arrangement zone information.

4. The method according to claim 3, wherein the image sensor is formed on an upper part of a body exposed when the door of the artificial intelligence device is opened, and is configured to sense a lower direction of the body.

5. The method according to claim 4, wherein the body includes at least one shelf, and an outer end of each shelf corresponds to the detection zone.

6. The method according to claim 5, wherein the step of obtaining information on insertion or removal of an object and calculating location information of the object based on the obtained first and second image data of the body part of the user includes:
obtaining an image of a hand of the user passing through the detection zone and calculating information on an entry angle of a wrist or arm and the length of the arm that passed through the detection zone; and
identifying whether the object is entered or released from the obtained hand image and calculating information on an arrangement zone where the object is entered or retreated from the calculated entry angle of the wrist or arm and the length of the arm that passed through the detection zone.

7. The method according to claim 6, wherein the step of generating object management information based on the obtained information on insertion or removal of the object and the location information includes identifying the object being entered or released when the object is entered or retreated from the image of the hand of the user passing through the detection zone, and
wherein the identification of the object is performed based on at least one of artificial intelligence-based pre-learned data or user's manual input information, and
wherein when a result of the identification of the object identification based on the information is unknown, the object is identified using at least one of a text reading, a barcode, or the user's manual input information.

8. The method according to claim 7, wherein when the result of the identification of the object is unknown and the object is entered, the object identification information is replaced with image information for each object being entered.

9. An artificial intelligence device comprising:
a memory; and
a processor configured to communicate with the memory,
wherein the processor is configured to detect door opening, activate an image sensor when the door is opened, obtain, using the activated image sensor, first image data of a body part of a user entering a detection zone and second image data of the body part of the user retreating from the detection zone, obtain information on insertion or removal of an object and calculate location information of the object based on the obtained first and second image data of the body part of the user, generate object management information based on the obtained information on insertion or removal of the object and the location information, and store the generated object management information.

10. The artificial intelligence device according to claim 9, wherein the processor is configured to detect a door closing, and control the stored object management information to be output when the user is detected using a detection sensor provided an outside of the artificial intelligence device after the door closing or when the door is closed, and
wherein the object management information includes recommended object insertion/removal arrangement zone information.

11. The artificial intelligence device according to claim 10, wherein the image sensor is formed on an upper part of the body exposed when the door of the artificial intelligence device is opened, and is configured to sense a lower direction of the body.

12. The artificial intelligence device according to claim 11, wherein the body includes at least one shelf, and an outer end of each shelf corresponds to the detection zone.

13. The artificial intelligence device according to claim 12, wherein the processor is configured to obtain an image of a hand of the user passing through the detection zone, calculate information on an entry angle of a wrist or arm and the length of the arm that passed through the detection zone, identify whether the object is entered or retreated from the obtained hand image, and calculate information on an arrangement zone where the object is entered or retreated from the calculated entry angle of the wrist or arm and the length of the arm that passed through the detection zone.

14. The artificial intelligence device according to claim 13, wherein the processor is configured to identify the object being entered or retreated from an image of the user's hand that passed through the detection zone, and
wherein the identification of the object is performed based on at least one of artificial intelligence-based pre-learned data or user's manual input information, and when a result of the identification of the object based on the information is unknown, the object is identified using at least one of a text reading, a barcode, or the user's manual input information.

15. The artificial intelligence device according to claim 14, wherein when the result of the identification of the object is unknown and the object is entered, the processor is configured to replace the object identification information with image information for each object being entered.
